(19) United States
(12) Patent Application Publication
(10) Pub. No.: US 2002/0145592 A1
(43) Pub. Date: Oct. 10, 2002

(54) Method of data entry

(76) Inventor: Lynn A. Schauer, Lincoln, ND (US)

Correspondence Address: Lynn A Schauer, 76 McDougal Dr., Lincoln, ND, 58504, US

(21) Appl. No.: 10/092,788

(22) Filed: Mar. 2, 2002

Related U.S. Application Data
(60) Provisional application No. 60/273,475, filed on Mar. 2, 2001.

(51) Int. Cl. G09G 5/00

(52) U.S. Cl. 345/156

(57) ABSTRACT

A method for transforming ordered sequences of keystrokes entered on a keypad with nine or more keys into a full complement of alphanumeric characters, such as might be entered from a computer keyboard. The method can be utilized using any device that permits an operator to select one of nine or more positions in a particular sequence. The positions are arranged in a three by three or larger rectangular matrix. Example input devices include a computer keyboard, numeric keypad, a touch pad, and a digitizing pad The sequence and order of positions selected is suggested by the shape of the character as normally drawn by hand Using shapes already known to users makes the method easy to learn Using exact key sequences makes the process fast, accurate and easy to implement on a computing device by using a simple lookup table method

### RELATED APPLICATION

This application claims the benefit of U.S. Provisional application No. 60/273,475

Filed on Mar. 2, 2001

By Lynn A. Schauer

Titled Method of data entry for small electronic devices.

### BACKGROUND OF INVENTION

As electronic devices become more sophisticated, the need for some form of data input becomes more common. As those devices become smaller, there is less room available for standard keyboards or keypads. As keyboards become smaller, fast and accurate data entry becomes more difficult. Attempts at handwriting recognition are either inaccurate, hard to learn, slow, expensive or difficult to implement. Accurate voice input is difficult to implement and not appropriate for many situations.

### ADVANTAGES OF INVENTION

My invention provides a method of data entry that fits in a physically small space, is easy to learn to use, is very accurate, fast and easy to implement using currently available technologies.

### BRIEF DESCRIPTION OF IMAGES

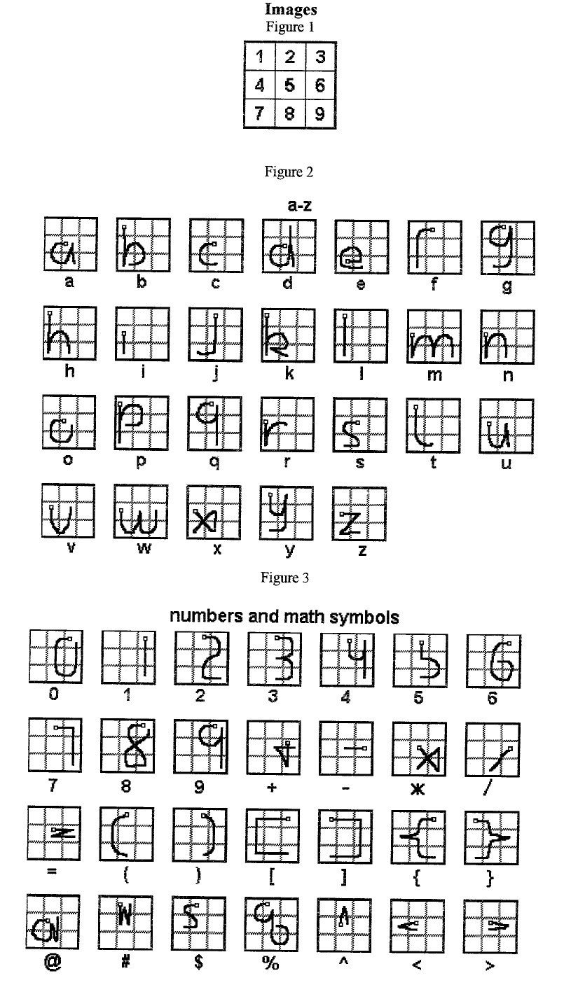

FIG. 1 shows the layout of a 3×3 touch pad, the numbers would not necessarily be there, but are included to make the rest of the descriptions easier to follow.

FIGS. 2 through 5 show the sequence and order of regions selected for various characters

FIG. 2 sequences for letters

FIG. 3 sequences for numbers and math symbols

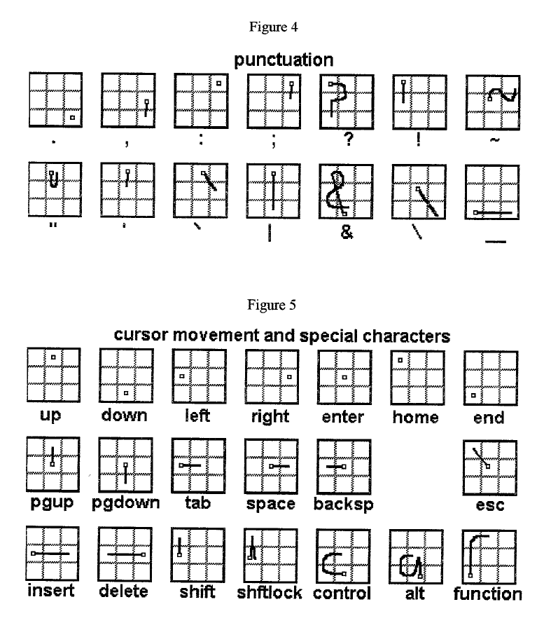

FIG. 4 sequences for punctuation

FIG. 5 sequences for cursor movement and special characters.

### DETAILED DESCRIPTION OF INVENTION

My method of data entry uses a rectangular region of keys or regions on a touchpad which could be implemented in whatever size and method that is convenient. The user selects the keys in the proper sequence and order, in effect drawing the desired character on the keys or touchpad as shown in FIGS. 2 through 5. A few simple rules make the exact sequences easy to remember.

### EXAMPLE 1

Select segment 5, then select segments 4, then 7 and 8. Notice that you have drawn the letter c. The computing device would simply recognizes this sequence 5478 as the letter c using a fairly simple lookup table. The fact that it looks like the letter c makes it very easy to remember.

### EXAMPLE 2

Select segment 5 then segments 4, 7, 8 then 5. Notice that you have drawn the letter o, and the computing device would recognize this sequence 54785 as the letter o.

### EXAMPLE 3

Select segment 5 then segments 4, 7, 8, 5, and 8. You have drawn the letter a and the computing device would recognize this sequence 547858 as the letter a.

My method defines similar unique sequences for all the letters a to z, the numbers 0 to 9 and in fact all the characters found on a standard computer keyboard.

Lifting the pointer, in the case of a using a touch pad, or pausing for a predetermined length of time, in the case of using a key pad, normally signals the end of the character being drawn. Holding the pointer in the last position or holding the last key for a predetermined time could also be used to signal both the end of the character and then also repeat the character as long as that position is held.

Special Rules:

By following certain rules, the sequence and order of keys or regions selected becomes even easier to learn and remember.

See FIG. 2. My method uses the following rules for the letters a-z:

All the letters are drawn in the lower left corner of the pad with the following exceptions—only the wide letters (m and w) extend into the third or rightmost column, only the tall letters (having ascenders or descenders) extend into the first or top row.

All letters consist of a single stroke, no need to dot the i or cross the t.

All the letters (except t and x) are the lower case shapes that most people would be familiar with.

See FIG. 3. My method uses the following rules for the numbers 0-9:

All the numbers are three rows tall and all are drawn on the right side of the pad, none extend into the first column.

The number 1 is the same as the letter l, but drawn in the third column.

The symbol * is the same as the letter x, only drawn on the right side of the pad.

The $ symbol is the same as the letter s, only drawn at the top of the pad.

The @ symbol is the letter a, extended back to the center segment.

See FIG. 4. My method uses the following rules for the punctuation characters:

The period is a simple tap in segment 9 (in the third column along with the other number symbols).

The comma is a short stroke from segment 6 to 9 (also positioned with the number symbols and positioned right above the period symbol).

The colon is a simple tap in segment 3 (a high period.).

The semicolon is a short stroke from segment 3 to 6 (a high comma.).

The exclamation mark is a high letter i.

The pipe symbol | is the same as the letter l and the number 1, but located in the middle column.

The others were similarly chosen to make them easy to remember and draw.

See FIG. 5 My method uses the following rules for cursor movement:

Up, down, left and right are simple taps in segments 2, 4, 6 and 8 respectively. Enter (or Select) is a simple tap in the center region (region 5). These form the traditional diamond shape for cursor movement.

Shift and Shift Lock would be used to generate upper case letters. Letters are always drawn in their lower case shapes.

Control, Alt, and Function are the letters c, a and f drawn backwards from their normal direction, and would be used to modify the following characters entered.

The other characters are chosen to be logical and easy to remember.

### SUMMARY

In essence, the user draws the characters on the specified keys or regions using a simple set of rules. This generates a number sequence which the computing device can use with a lookup table of required key sequences to determine the character drawn. This invention uses a novel combination of widely used techniques to provide a simple yet elegant solution to data entry on electronic devices without requiring a large amount of space.

Best Implementation:

Although this technique would work with almost any type of keyboard, keypad, touch pad or digitizing pad, it would be best implemented using a smooth touch pad or digitizing pad where the pointing device could be moved smoothly and quickly from one segment to the next.

Also by using a special lookup table method certain sloppiness in drawing the character can be allowed for. I recommend a method which I call a reverse lookup table.

For example, the following is just a small portion of the lookup table:

“2” 2389

“a” 547858

“o” 54785

“c” 5478

There is at least one entry in the lookup table for each character to be recognized. Certain characters may have multiple entries to allow for more than one drawing sequence for that character. Each entry has a list of required selections in the proper sequence along with the character for that sequence. The table is arranged so that the most complex characters are searched first, followed by simpler characters.

After the user has entered a sequence of key strokes, the computing device compares each of the table entry sequences with the entry sequence, until a match is found. A match is considered found when each of the required selections from that table entry are found in the proper order in the entered sequence. There may or may not be extra selections between the required selections in the entered selections.

### EXAMPLE 1

When the user draws the letter ‘“o”, the entered sequence is 54785. A normal lookup would proceed through the table looking for a match for 54785. A better method is to use a reverse lookup, proceeding through the lookup table looking for a match for each table entry in the entered sequence. Using the table above would first look for a match to 2389 in the entered sequence. It would not be found, so the search would continue with 547858. That would also not match because of the final 8 in the table sequence would not be found in the entered sequence. The search would then continue until a match is found for the letter “o”.

### EXAMPLE 2

### Illustrating Required Selections

The table sequence for the number 2 is 2389. Any of the sequences 236589, 236989, or 23698569 would be recognized as the number 2, as long as the sequence drawn does not match a more complicated character sequence first. This is accomplished by only looking for the required selections in the proper order in the generated sequence. Each of the entered sequences 236589, 236989 and 23698569 have all the required selections 2389 in the proper order, with the extra selections in the generated sequence being simply ignored.

This lookup algorithm and the exact structure of the lookup table itself provide a great deal of intelligence and flexibility in recognizing characters.

FIGS. 1 through 5 illustrate only one possible implementation of my method. It would be obvious that the method could be implemented with a larger array of keys and different sets of character sequences and additional characters could be easily added. A larger array of keys may be necessary for other language character sets.

1. I claim a method of data entry:
A) which uses a limited number of keys to generate a multitude of characters,
B) where said characters may include but are not limited to text, numbers, punctuation marks, cursor movement and shift characters,
C) where said keys are arranged in a 3×3 or larger rectangular array, and may be part of a larger such array,
D) where said keys are connected to an electronic computing device in such a way that the said computing device can determine the sequence and order of keys selected,
E) where said computing device uses the sequence and order of keys selected to compute the desired character,
F) where said keys are selected in a specific order and sequence to identify the character,
G) where the sequence of said key selections for different characters varies in count from one to many keys,
H) where the sequence and order of key selections for particular characters is suggested by the shape of the characters as normally drawn by hand,
I) where the word “keys” above refers to actual keys on a keyboard or keypad, or to regions on a touch pad or digitizing pad whether marked or unmarked, or to any device capable of indicating to an electronic device that it has been selected by means of a finger, stylus or other pointing device.
